(19) United States
(12) Patent Application Publication
(10) Pub. No.: US 2019/0187452 A1
(43) Pub. Date: Jun. 20, 2019

(54) MICROSCOPE

(71) Applicant: SHIMADZU CORPORATION, Kyoto-shi (JP)

(72) Inventor: Yasushi NAKATA, Kyoto-shi (JP)

(73) Assignee: SHIMADZU CORPORATION, Kyoto-shi (JP)

(21) Appl. No.: 15/843,032

(22) Filed: Dec. 15, 2017

(51) Int. Cl. G02B 21/26; H04N 5/33; G01N 21/35

(52) U.S. Cl. CPC G02B 21/26; G01N 21/35; H04N 5/33

(57) ABSTRACT

A microscope including a measurement light source for emitting measurement light to a measurement point on a sample; a detector for detecting measurement light from the measurement point on the sample; an XY stage mechanism capable of moving a sample stage on which the sample is placed; an input device for inputting input information serving as a measurement range on the sample comprising a plurality of measurement points; and a controller part for controlling the XY stage mechanism and obtaining measurement light information in the measurement range on the sample on the basis of the input information.

The entire content of JP Patent Publication No. 2017-009718, published Jan. 12, 2017, and having the same inventors, is hereby incorporated by reference.

### TECHNICAL FIELD

The present invention relates to a microscope for irradiating a microscopic measurement point on a surface of a macroscopic sample with measurement light such as infrared light, ultraviolet light, or visible light.

### BACKGROUND ART

An infrared microscope is used, for example, for the purpose of studying the molecular structure or the like of an organic substance adhering to the surface of a solid (sample) based on the functional groups of the substance. Specifically, a specific minute site (for example, a measurement point of 15 μm×15 μm) on the surface of the sample is irradiated with infrared light focused to a small diameter. Since a spectrum unique to the molecular structure or the like based on the functional groups of the organic substance or the like is generated from the specific measurement point on the sample surface, this spectrum is detected and analyzed so as to identify and assay the organic substance or the like (for example, see Patent Document 1.)

Such an infrared microscope includes an image acquisition device such as a CCD camera or a CMOS camera to allow an analyst to observe the sample surface, and the measurement point on the sample surface is determined while an optical image of the sample surface is being observed. For example, by irradiating a region (for example, a region of 500 μm×400 μm) including the measurement point on the sample surface with visible light from a light source such as a halogen lamp and detecting the visible light reflected by the region including the measurement point on the sample surface with a CCD camera, an optical image is created on the basis of the detected visible light. As a result, the analyst designates the infrared light irradiation position on the sample (for example, a measurement point of 15 μm×15 μm) or designates a measurement range on the sample (for example, a range of 300 μm×200 μm) while observing the optical image.

FIG. 4 illustrates the relevant configuration of a conventional infrared microscope. Note that one direction horizontal to the ground is defined as the X-direction, the direction horizontal to the ground and perpendicular to the X-direction is defined as the Y-direction, and the direction perpendicular to the X-direction and the Y-direction is defined as the Z-direction.

An infrared microscope 101 includes: an XY stage mechanism 10 which a sample S is placed; an infrared light source 20 for emitting infrared light; a visible light source 30 for emitting visible light; a detection part 240 for detecting infrared light; an image acquisition device 50 having a detection surface for detecting visible light; Cassegrain mirrors 260 and 261; a plate-shaped switching mirror 270; and a computer 190 for controlling the entire infrared microscope 101.

Although not illustrated in the drawing, the XY stage mechanism 10 includes a stage (sample stage,) an X-direction driving mechanism, and a Y-direction driving mechanism.

A sample S can be placed on and removed from the upper surface of the stage. Such a stage can move in the desired X-direction and Y-direction when a driving signal required for the driving mechanism is outputted by a spectrum acquisition part 191c of the computer 190.

The infrared light source 20 is a Fourier transform infrared spectrophotometer for emitting infrared light (interferogram) which changes in intensity over time. The infrared light source 20 is disposed so that after the emitted infrared light is reflected by a mirror 21, a switching mirror 22, a transmission/reflection switching mirror 23, concave mirrors 24 and 25, or semi-transparent mirrors 26 and 27, the light is focused by the Cassegrain mirrors 260 and 261 irradiated onto a measurement point (for example, 15 μm×15 μm) on the sample S placed on the XY stage mechanism 10.

The detection part 240 includes a detector 241 and a converging mirror 242 or a mirror 243 disposed in front of the detector 241.

The visible light source 30 emits visible light. The visible light source 30 is disposed so that after the emitted visible light is transmitted or reflected by a lens 31, the switching mirror 22, the transmission/reflection switching mirror 23, the concave mirrors 24 and 25, or the semi-transparent mirrors 26 and 27, the light is focused by the Cassegrain mirrors 260 and 261 and irradiated onto a region (for example, a region of 500 μm×400 μm) including the measurement point on the surface of the sample S placed on the XY stage mechanism 10.

The image acquisition device 50 includes a CCD camera 51 having a detection surface for detecting visible light and a relay lens 52 disposed in front of the CCD camera 51.

In order for the image acquisition device 50 to acquire an optical image of the region including the measurement point on the surface of the sample S with the same optical axis (light path) as the optical system which guides infrared light to the detection part 240, a switching mirror 270 capable of moving on the light path and to positions not on light path is disposed on the light path for guiding infrared light to the detection part 240 above (−Z-direction) the XY stage mechanism 10.

As a result, infrared light from the measurement point on the sample S is focused by the Cassegrain mirror 260 to form infrared light advancing in a prescribed direction (−Z-direction,) and after the infrared light is reflected in the −X-direction by the switching mirror 270 disposed on the light path, the light is detected by the detection part 240. In addition, after visible light from the region including the measurement point on the surface of the sample S is focused by the Cassegrain mirror 260 to form visible light advancing in a prescribed direction (−Z-direction,) the light is detected by the detection surface of the CCD camera 51.

The computer 190 includes a CPU (control part) 191 and a storage part 194, and a monitor (display device) 93 and an operation part (input device) 92 are further connected thereto. In addition, to explain the functions processed by the CPU 191 in terms of blocks, the CPU 191 has: an optical image acquisition part 91a for acquiring an optical image from the image acquisition device 50 and displaying the optical image on the monitor 93; an input information acquisition part 91b into which input information (measurement range on the sample S) is inputted by the operation part 92; a spectrum acquisition part 191c for acquiring infrared light information for the measurement points on the sample S from the detection part 240 while moving the stage in the X-direction and the Y-direction on the basis of the input information and storing the information in the storage part 194; and a spectrum display control part 191d for calculating the infrared spectrum by performing a Fourier transform on the infrared light information and displaying an infrared spectrum distribution image on the monitor 93.

The input information acquisition part 91b administers control to make the storage part 194 store the input information (measurement range on the sample S) from the operation part 92.

For example, the analyst uses the operation part (mouse dragging operation or the like) 92 while observing the optical image displayed on the monitor 93 to designate the execution of a “line mapping,” wherein the irradiation positions of infrared light (for example, measurement point of 15 μm×15 μm) are arranged linearly at equal intervals (for example, 30 μm intervals,) a “two-dimensional mapping,” wherein the irradiation positions of infrared light (for example, measurement point of 15 μm×15 μm) are arranged at equal intervals (for example, 50 μm intervals) in the X-direction and the Y-direction, or a “random mapping” resulting in any plurality of irradiation positions of infrared light (for example, measurement point of 15 μm×15 μm.)

Here, FIG. 5 illustrates an example of a monitor screen displayed by the infrared microscope 101. An optical image (for example, 300 μm×400 μm) acquired from the image acquisition device 50 is displayed on the monitor 93. Note that if the magnification factor of the optical image displayed on the monitor 93 is changed, the optical image is displayed in accordance with the magnification factor.

In addition, “two dimensional mapping” is selected by the operation part 92 so that a measurement image with the rectangular shape of the boldface line illustrating the measurement range (for example, 200 μm×320 μm) of the “two-dimensional mapping” is displayed on the optical image.

After setting the coordinates of measurement points to the measurement range on the basis of the input information, the spectrum acquisition part 191c acquires infrared light information for measurement points on the sample S from the detection part 240 while moving the stage in the X-direction and the Y-direction and controls the storage part 194 to store the information.

For example, defining the upper left end of the rectangular measurement range image as the origin (x₀, y₀,) the spectrum acquisition part 191c sets the X-coordinates of the measurement points x₀, x₁, . . . , x₄ so that the upper left end of the rectangular measurement range image and the upper right end of the rectangular measurement range image are divided into four equal parts, sets the Y-coordinates of the measurement points y₀, y₁, . . . , y₈ so that the upper left end of the rectangular measurement range image and the lower left end of the rectangular measurement range image are divided into eight equal parts, and thereby sets the coordinates (black circles) of a total of 45 measurement points.

The spectrum acquisition part 191c then moves the stage so that a first measurement point (x₀, y₀) arrives at a prescribed position, acquires infrared light information from the first measurement point (x₀, y₀) and stores the information in the storage part 194, moves the stage so that a second measurement point (x₁, y₀) arrives at a prescribed position, acquires infrared light information from the second measurement point (x₁, y₀,) and stores the information in the storage part 194. The spectrum acquisition part 191c continues to move the stage in this manner so that the 45 measurement points sequentially arrive at prescribed positions, and then acquires infrared light information from the 45 measurement points and stores the information in the storage part 194.

The spectrum display control part 191d administers control to display the infrared spectrum distribution image of the measurement range on the monitor 93 on the basis of the infrared light information from the 45 measurement points (x₀, y₀) to (x₄, y₈) stored in the storage part 194.

### PRIOR ART DOCUMENTS

### Patent Document

[PATENT DOCUMENT 1] Japanese Unexamined Patent Application Publication 2000-121554

### SUMMARY OF INVENTION

### Problems to be Solved by the Invention

Incidentally, with the infrared microscope 101 described above, when the analyst determines that a peak of interest extends outside the measurement range as a result of observing the infrared spectrum distribution image displayed on the monitor 93, the analyst once again re-designates the measurement range on the sample S to acquire a new infrared spectrum distribution image. At this time, in a “two-dimensional mapping,” the number of measurement points is as large as 45 points, as illustrated in FIG. 5, so the mapping takes an immense amount of time.

### Means for Solving the Problems

The present applicant investigated methods for acquiring a spectrum distribution image for a desired measurement range on a sample S in a short amount of time. In a mapping measurement (two-dimensional mapping,) when all of the measurement points (45 measurement points) are handled as one group and input information (measurement range on the sample S) is inputted, a spectrum measurement is performed for all of the measurement points without omitting spectrum measurements for some of the measurement points. Therefore, when the measurement range is re-designated at the point when it is determined that a peak of interest extends outside the measurement range, even if there are overlapping portions in the measurement range before and after modification and there are common measurement points before and after modification, the results of the spectrum measurement executed prior to modification are first abandoned, and a spectrum measurement is newly executed for all of the measurement points included in the measurement range after modification.

Therefore, the present applicant discovered that when the measurement range is modified and a mapping measurement is once again executed after a mapping measurement is first executed, if there is overlap in the measurement points before and after the modification of the measurement range, the results of the spectrum measurement already obtained for those measurement points may be kept, and a spectrum measurement may be newly executed for only the non-overlapping measurement points.

The microscope of the present invention, which was conceived in order to solve the problems described above, comprises: a measurement light source for emitting measurement light to a measurement point on a sample; a detector for detecting measurement light from the measurement point on the sample; an XY stage mechanism capable of moving a sample stage on which the sample is placed; an input device for inputting input information serving as a measurement range on the sample comprising a plurality of measurement points; and a controller for controlling the XY stage mechanism and obtaining measurement light information in the measurement range on the sample on the basis of the input information; the controller executing an (n-1)th information acquisition step of controlling the XY stage mechanism on the basis of (n-1)^{th} information serving as an (n-1)^{th} measurement range inputted by the input device, obtaining measurement light information in the (n-1)^{th} measurement range, and storing the information in a storage, and then executing an n^{th} acquisition step of controlling the XY stage mechanism on the basis of nth input information serving as an n^{th} measurement range inputted by the input range and acquiring measurement light information of the n^{th} measurement range; and in the n^{th} acquisition step, the controller using measurement light information in an overlapping part stored in the storage in the (n-1)^{th} acquisition step to create measurement light information of the nth measurement range without acquiring measurement light information in an overlapping portion of the n^{th} measurement range overlapping the (n-1)^{th} measurement range.

Here, examples of “measurement light” include infrared light, ultraviolet light, and visible light. In addition, changes in intensity over time may also be induced with an interferometer or another modulation means.

Further, “n” is a natural number not less than 1.

### Effect the Invention

As described above, with the microscope of the present invention, measurement points that newly require spectrum measurement (acquisition of measurement light information) are only those present in portions not included in the measurement range prior to modification among the measurement points in the measurement range after modification. As a result, the number of measurement points for which a spectrum measurement is executed becomes small, which makes it possible to reduce the measurement time.

### Other Means for Solving the Problem, and Effects Thereof

In addition, in the microscope of the present invention, measurement points arranged at equal intervals in an X-direction and a Y-direction may be set in the n^{th} measurement range and the (n-1)^{th} measurement range.

With the microscope of the present invention, it is possible to prevent the ratios of changes for each acquired position of a spectrum (measurement light information) from becoming non-uniform as a result of measurement points in the overlapping portion within the measurement range prior to modification and the measurement points not in the overlapping portion not being evenly spaced and changes in the positions of the measurement points being non-uniform.

Further, the microscope of the present invention may comprise: a visible light source for emitting visible light in a region including the measurement point on the sample; and an image acquisition device for acquiring an optical image and displaying the optical image on a display device when visible light from the region including the measurement point on the sample is incident on a detection surface; wherein the input information is inputted using the optical image.

### BRIEF DESCRIPTION OF THE DRAWINGS

FIG. 1 illustrates the relevant configuration of a microscope according to an embodiment of the present invention.

FIG. 2 illustrates an example of a monitor screen displayed by an infrared microscope.

FIG. 3 illustrates another example of a monitor screen displayed by an infrared microscope.

FIG. 4 illustrates the relevant configuration of a conventional infrared microscope.

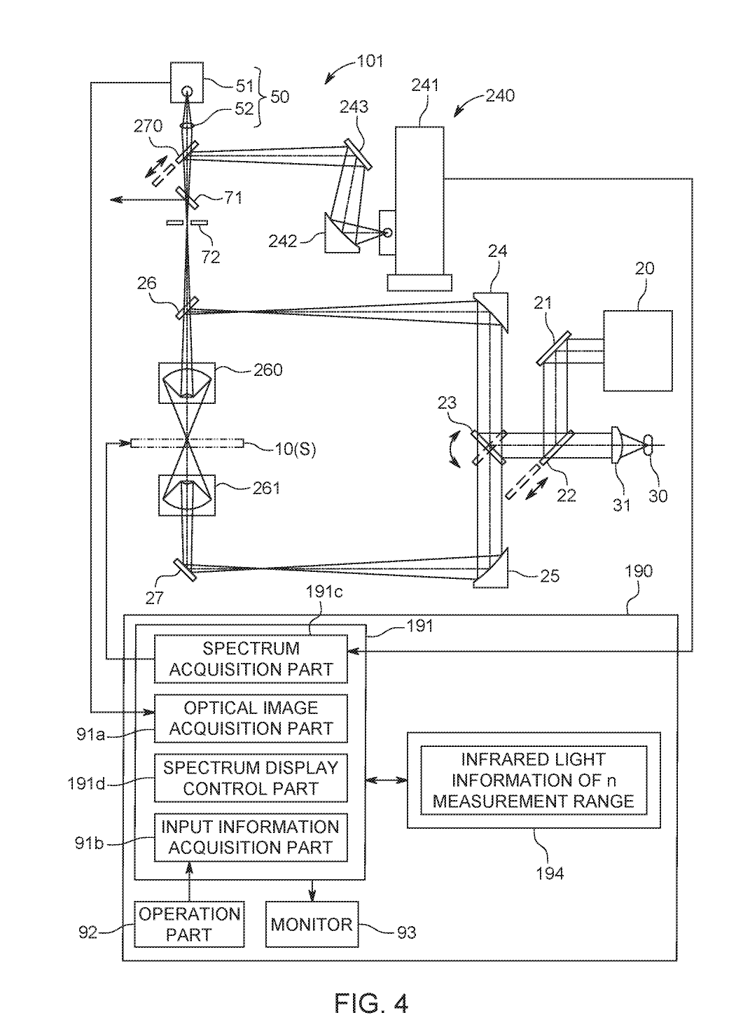

FIG. 5 illustrates an example of a monitor screen displayed by the infrared microscope illustrated in FIG. 4.

### MODES FOR CARRYING OUT THE INVENTION

Embodiments of the present invention will be described hereinafter with reference to the drawings. Note that the present invention is not limited to embodiments such as those described below, and the present invention includes various modes within a scope that does not depart from the gist of the present invention.

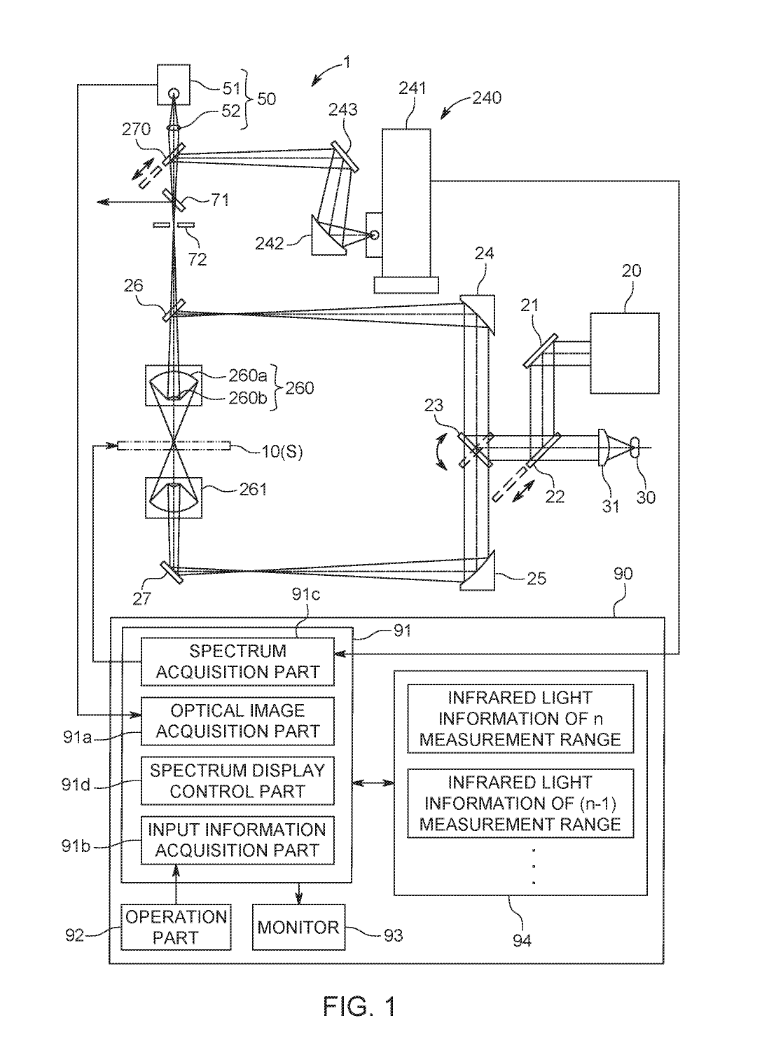

FIG. 1 illustrates the relevant configuration of a microscope according to an embodiment of the present invention. Note that components that are the same as those of the infrared microscope 101 described above are labeled with the same symbols.

An infrared microscope 1 includes: an XY stage mechanism 10 on which a sample S is placed; an infrared light source 20 for emitting infrared light; a visible light source 30 for emitting visible light; a detection part 240 for detecting infrared light; an image acquisition device 50 having a detection surface for detecting visible light; Cassegrain mirrors 260 and 261; a plate-shaped switching mirror 270; and a computer 90 for controlling the entire infrared microscope 1.

The Cassegrain mirror (Schwarzschild reflective/objective mirror) 260 includes a main Cassegrain mirror 260a and a secondary Cassegrain mirror 260b.

The secondary Cassegrain mirror 260b has a circular shape when viewed from the Z-direction, wherein the upper surface is a convex surface having a hemispherical shape and the lower surface is a flat surface when viewed from the Y-direction or the X-direction. The secondary Cassegrain mirror 260b is disposed above the XY stage mechanism 10 and is disposed so that the upper surface faces upward (−Z-direction.) In addition, the main Cassegrain mirror 260a has a ring shape having an opening with the same shape as that of the secondary Cassegrain mirror 260b when viewed from the Z-direction, wherein the lower surface is a concave surface having a hemispherical shape and the upper surface is a flat surface when viewed from the Y-direction or the X-direction. The main Cassegrain mirror 260a is disposed above the XY stage mechanism 10 and above the secondary Cassegrain mirror 260b and is disposed so that the upper surface faces upward (−Z-direction.)

As a result, after infrared light from the infrared light source 20 is reflected by the secondary Cassegrain mirror 260b, the light is focused by the main Cassegrain mirror 260a so that measurement points on the sample S are irradiated. In addition, after light from a region including the measurement points on the sample S is focused by the main Cassegrain mirror 260a, the light is reflected by the secondary Cassegrain mirror 260b so as to advance in the −Z-direction.

Note that the Cassegrain mirror (Schwarzschild reflective/objective mirror) 261 also has the same structure as the Cassegrain mirror 260 and is disposed with vertical symmetry while sandwiching the XY stage mechanism 10.

The computer 90 includes a CPU (controller) 91 and a storage 94, and a monitor (display device) 93 and an operation part (input device) 92 are further connected thereto. In addition, to explain the functions processed by the CPU 91 in terms of blocks, the CPU 91 has: an optical image acquisition part 91a for acquiring an optical image from the image acquisition device 50 and displaying the optical image on the monitor 93; an input information acquisition part 91b into which input information (measurement range on the sample S) is inputted by the operation part 92; a spectrum acquisition part 91c for acquiring infrared light information for the measurement points on the sample S from the detection part 240 while moving the stage in the X-direction and the Y-direction on the basis of the input information and storing the information in the storage part 94; and a spectrum display control part 91d for calculating the infrared spectrum by performing a Fourier transform on the infrared light information and displaying an infrared spectrum distribution image on the monitor 93.

The input information acquisition part 91b administers control to make the storage part 94 store the input information (n^{th} measurement range on the sample S) from the operation part 92.

After the spectrum acquisition part 91c sets the coordinates of measurement points in the nth measurement range on the basis of the n^{th} input information and the infrared light information stored in the storage part 94, the spectrum acquisition part 91c acquires infrared light information for the measurement points on the sample S from the detection part 240 while moving the stage in the X-direction and the Y-direction and controls the storage 94 to store the information.

(1) When there is no infrared light information in the storage 94

(That is, when Acquiring Infrared Light Information for the First Measurement Range)

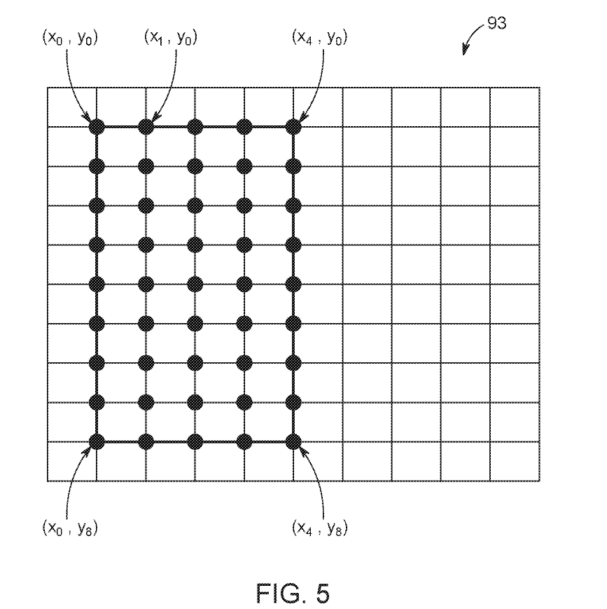

For example, defining the upper left end of the first measurement range image as the origin (x₀, y₀,) the spectrum acquisition part 91c sets the X-coordinates of the measurement points x₀, x₁, . . . , x₄ so that the upper left end of the first measurement range image and the upper right end of the first measurement range image are divided into four equal parts, sets the Y-coordinates of the measurement points y₀, y₁, . . . , y₈ so that the upper left end of the first measurement range image and the lower left end of the first measurement range image are divided into eight equal parts, and thereby sets the coordinates of a total of 45 measurement points (see FIG. 5.)

The spectrum acquisition part 91c then moves the stage so that a first measurement point (x₀, y₀) arrives at a prescribed position, acquires infrared light information from the first measurement point (x₀, y₀) and stores the information in the storage part 94, moves the stage so that a second measurement point (x₁, y₀) arrives at a prescribed position, acquires infrared light information from the second measurement point (x₁, y₀,) and stores the information in the storage part 94. The spectrum acquisition part 91c continues to move the stage in this manner so that the 45 measurement points sequentially arrive at prescribed positions, and then acquires infrared light information from the 45 measurement points and stores the information in the storage part 94. Note that in the infrared microscope 1, even if the acquisition of infrared light information from 45 measurement points is interrupted at an intermediate stage without being completed, or even if there are only spectrum measurement results for some of the measurement points, the information is stored in the storage part 94.

(2) When there is infrared light information for the first measurement range in the storage part 94 when measuring the same sample S under the same measurement conditions (aperture settings, background spectrum, and the like)

(That is, when Acquiring Infrared Light Information for the Second Measurement Range)

The spectrum acquisition part 91c compares the first measurement range and the second measurement range and sets measurement points in a non-overlapping portion of the second measurement range that does not overlap with the first measurement range using a grid of the first measurement range (origin (x₀, y₀,) X-direction intervals, and Y-direction intervals.) That is, the measurement points in the measurement range after modification are also set based on the same origin (x₀, y₀) as the measurement points in the measurement range prior to modification. As a result, the upper left end of the second measurement range is not on the grid points, so when measurement points are set using this as the origin, a discrepancy arises relative to the measurement points of the first measurement range, but the disruption of continuity is prevented.

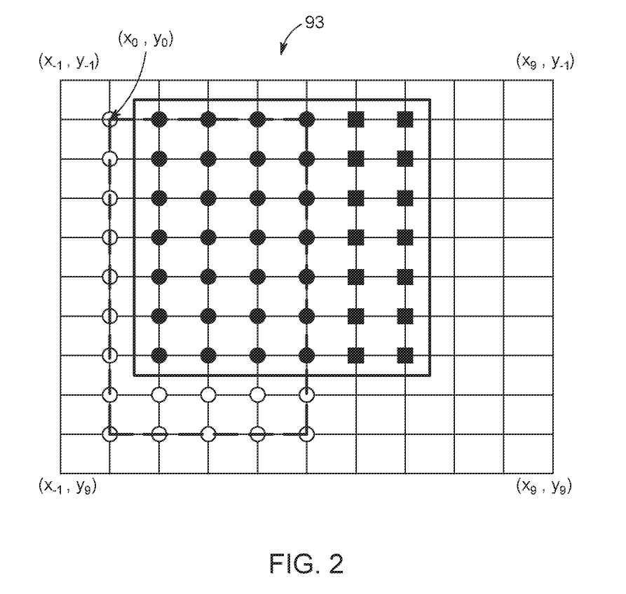

FIG. 2 illustrates an example of a monitor screen displayed by the infrared microscope 1. An optical image (for example, 500 μm×400 μm) acquired from the image acquisition device 50 is displayed on the monitor 93. In addition, a first measurement range image of a dotted line indicating the first measurement range (for example, 200 μm×300 μm) is also displayed. The upper left end of the first measurement image then becomes the origin (x₀, y₀,) and the X-coordinates of the measurement points x₀, x₁, . . . , x₄ are set so that that the upper left end of the first measurement range image and the upper right end of the first measurement range image are divided into four equal parts, while the Y-coordinates of the measurement points y₀, y₁, . . . , y₈ are set so that the upper left end of the first measurement range image and the lower left end of the first measurement range image are divided into eight equal parts. the coordinates (black circles and white circles) of a total of 45 measurement points are thereby set.

In addition, a second measurement range image of a boldface line indicating the second measurement range (for example, 250 μm×240 μm) is also displayed. Coordinates (black squares) of 14 measurement points are then set around the origin (x₀, y₀) in the non-overlapping portion of the second measurement range that does not overlap with the first measurement range.

The spectrum acquisition part 91c then moves the stage so that a 46th measurement point (x₅, y₀) arrives at a prescribed position, acquires infrared light information from the 46th measurement point (x₅, y₀) and stores the information in the storage part 94, moves the stage so that a 47th measurement point (x₆, y₀) arrives at a prescribed position, acquires infrared light information from the second measurement point (x₆, y₀,) and stores the information in the storage part 94. The spectrum acquisition part 91c continues to move the stage in this manner so that the 14 measurement points sequentially arrive at prescribed positions, and then acquires infrared light information from the 14 measurement points and stores the information in the storage part 94.

(3) When there is infrared light information for the (n-2)^{th} measurement range and infrared light information for the (n-1)^{th} measurement range when measuring the same sample S under the same measurement

(That is, when Acquiring Infrared Light Information for the n^{th} Measurement Range)

The spectrum acquisition part 91c compares the (n-2)^{th} measurement range, the (n-1)^{th} measurement range, and the n^{th} measurement range and sets measurement points in a non-overlapping portion of the n^{th} measurement range that does not overlap with either the (n-2)^{th} measurement range or the (n-1)^{th} measurement range using a grid of the first measurement range. In addition, the spectrum acquisition part 91c sets measurement points in an overlapping portion of the (n-3)^{th} measurement range, the (n-1)^{th} measurement range, and the n^{th} measurement range using the origin (x₀, y₀) and intervals of the first measurement range. That is, although there is infrared light information in measurement ranges prior to the (n-3)^{th} measurement range, with the infrared microscope 1 of the present invention, the concentration of ambient water vapor or carbon dioxide changes as time passes after the acquisition of the infrared light information, and the difference relative to the results of newly performed spectrum measurements becomes large, so they are set so as to not be used.

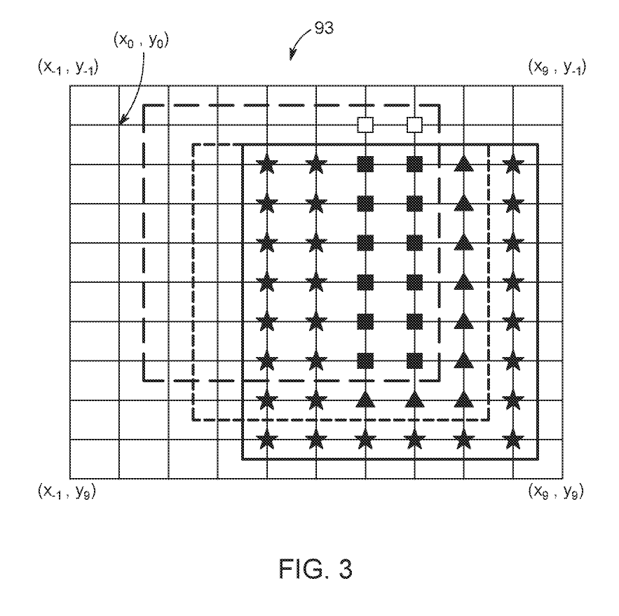

FIG. 3 illustrates another example of a monitor screen displayed by the infrared microscope 1. An optical image (for example, 500 μm×400 μm) acquired from the image acquisition device 50 is displayed on the monitor 93. In addition, an (n-2)^{th} measurement range image of a dotted line indicating the (n-2)^{th} measurement range (for example, 250 μm×240 μm) is also displayed. Coordinates (black squares and white squares) of fourteen measurement points are then set around the origin (x₀, y₀) in the non-overlapping portion of the (n-2)^{th} measurement range that does not overlap with either the (n-4)^{th} measurement range or the (n-3)^{th} measurement range.

In addition, an (n-1)^{th} measurement range image of a dotted line indicating the (n-1)^{th} measurement range (for example, 250 μm×240 μm) is also displayed. Coordinates (black triangles) of nine measurement points are set around the origin (x₀, y₀) in the non-overlapping portion of the (n-1)^{th} measurement range that does not overlap with either the (n-3)^{th} measurement range or the (n-2)^{th} measurement range.

Further, an nth measurement range image of a boldface line indicating the n^{th} measurement range (for example, 250 μm×240 μm) is also displayed. Coordinates (black star shapes) of 13 measurement points are set around the origin (x₀, y₀) in the non-overlapping portion of the n^{th} measurement range that does not overlap with either the (n-2)^{th} measurement range or the (n-1)^{th} measurement range. In addition, coordinates (black star shapes) of 14 measurement points are set around the origin (x₀, y₀) in the overlapping portion of the (n-3)^{th} measurement range, the (n-1)^{th} measurement range, and the n^{th} measurement range.

The spectrum acquisition part 91c then moves the stage so that the 13 new measurement points arrive at prescribed positions, acquires infrared light information from the 13 measurement points, stores the information in the storage 94, moves the stage so that the 14 measurement points arrive at prescribed positions after a prescribed amount of time has passed, acquires infrared light information from the 14 measurement points, and then stores the information in the storage 94.

The spectrum display control part 91d administers control to display the infrared spectrum display image of the n^{th} measurement range on the monitor 93 on the basis of the infrared light information from the measurement points of the n^{th} measurement range stored in the storage 94.

As described above, with the infrared microscope 1 of the present invention, measurement points that must be newly subjected to spectrum measurements (acquisition of measurement light information) are only those in the measurement range after modification that are present in portions not included in the measurement range prior to modification. As a result, the number of measurement points for which a spectrum measurement is executed becomes small, which makes it possible to reduce the measurement time.

In addition, even if the mapping measurement in the (n-1)^{th} measurement range is interrupted during the spectrum measurement as a result of mistakenly setting the (n-1)^{th} measurement range, the results of the completed spectrum measurements are not wasted, and the mapping measurement in the corrected n^{th} measurement range can be completed in a short period of time.

Further, in order to prevent the ratios of changes for each acquired position of a spectrum (measurement light information) from becoming non-uniform as a result of measurement points in the overlapping portion within the measurement range prior to modification and the measurement points not in the overlapping portion not being evenly spaced and changes in the positions of the measurement points being non-uniform, the grid-shaped arrangement of measurement points set in the measurement range prior to modification may be extended over the entire stage, and the measurement points in the measurement range after modification may be set on the grid points so as to keep all of the measurement points in the measurement range after modification at equal intervals.

### <Other Embodiments>

In the infrared microscope 1 described above, a configuration was employed in which the infrared light information of measurement regions prior to the (n-3)^{th} measurement range are not used, but the configuration may also be such that infrared light information of measurement regions prior to the (n-4)^{th} measurement range are not used, or such that infrared light information of measurement regions prior to a measurement range earlier than a prescribed time are not used.

### FIELD OF INDUSTRIAL APPLICATION

The present invention can be suitably applied to a microscope or the like which irradiates a sample with measurement light and detects the spectrum discharged from the sample as a result.

### EXPLANATION OF SYMBOLS

1 infrared microscope
10 XY stage mechanism
20 infrared light source (measurement light source part)
30 visible light source
91 CPU (controller)
92 operation part (input device)
94 storage
240 detection part

What is claimed is:

1. A microscope, comprising:
a measurement light source for emitting measurement light to a measurement point on a sample;
a detector for detecting measurement light from the measurement point on the sample;
an XY stage mechanism capable of moving a sample stage on which the sample is placed;
an input device for inputting input information serving as a measurement range on the sample comprising a plurality of measurement points; and
a controller for controlling the XY stage mechanism and obtaining measurement light information in the measurement range on the sample on the basis of the input information;
the controller executing an (n-1)th information acquisition step of controlling the XY stage mechanism on the basis of (n-1)^{th} information serving as an (n-1)^{th} measurement range inputted by the input device, obtaining measurement light information in the (n-1)^{th} measurement range, and storing the information in a storage, and then executing an n^{th} acquisition step of controlling the XY stage mechanism on the basis of nth input information serving as an n^{th} measurement range inputted by the input range and acquiring measurement light information of the n^{th} measurement range; and
in the n^{th} acquisition step, the controller using measurement light information in an overlapping part stored in the storage in the (n-1)^{th} acquisition step to create measurement light information of the nth measurement range without acquiring measurement light information in an overlapping portion of the n^{th} measurement range overlapping the (n-1)^{th} measurement range.

2. The microscope according to claim 1, wherein measurement points arranged at equal intervals in an X-direction and a Y-direction are set in the n^{th} measurement range and the (n-1)^{th} measurement range.

3. The microscope according to claim 1, comprising:
a visible light source for emitting visible light in a region including the measurement point on the sample; and
an image acquisition device for acquiring an optical image and displaying the optical image on a display device when visible light from the region including the measurement point on the sample is incident on a detection surface;
wherein the input information is inputted using the optical image.

4. The microscope according to claim 2, comprising:
a visible light source for emitting visible light in a region including the measurement point on the sample; and
an image acquisition device for acquiring an optical image and displaying the optical image on a display device when visible light from the region including the measurement point on the sample is incident on a detection surface;
wherein the input information is inputted using the optical image.

5. A method, comprising:
emitting measurement light to a measurement point on a sample;
detecting measurement light from the measurement point on the sample;
moving a sample stage on which the sample is placed;
inputting input information serving as a measurement range on the sample comprising a plurality of measurement points; and
controlling the XY stage mechanism and obtaining measurement light information in the measurement range on the sample on the basis of the input information;
wherein the control includes
executing an (n-1)th information acquisition step of controlling the XY stage mechanism on the basis of (n-1)^{th} information serving as an (n-1)^{th} measurement range inputted by the input device, obtaining measurement light information in the (n-1)^{th} measurement range, and storing the information in a storage, and then executing an n^{th} acquisition step of controlling the XY stage mechanism on the basis of nth input information serving as an n^{th} measurement range inputted by the input range and acquiring measurement light information of the n^{th} measurement range; and
in the n^{th} acquisition step, using measurement light information in an overlapping part stored in the storage in the (n-1)^{th} acquisition step to create measurement light information of the nth measurement range without acquiring measurement light information in an overlapping portion of the n^{th} measurement range overlapping the (n-1)^{th} measurement range.

6. The method according to claim 5, wherein measurement points arranged at equal intervals in an X-direction and a Y-direction are set in the n^{th} measurement range and the (n-1)^{th} measurement range.

7. The method according to claim 5, comprising:
emitting visible light in a region including the measurement point on the sample; and
acquiring an optical image and displaying the optical image on a display device when visible light from the region including the measurement point on the sample is incident on a detection surface;
wherein the input information is inputted using the optical image.

8. The method according to claim 6, comprising:
emitting visible light in a region including the measurement point on the sample; and
acquiring an optical image and displaying the optical image on a display device when visible light from the region including the measurement point on the sample is incident on a detection surface;
wherein the input information is inputted using the optical image.
